(19) United States
(12) Patent Application Publication
(10) Pub. No.: US 2026/0050925 A1
(43) Pub. Date: Feb. 19, 2026

(54) SYSTEM, METHOD AND APPARATUS FOR EMPLOYING MACHINE LEARNING TO PREVENT OVERDRAFT FEES

(71) Applicant: Affirm, Inc., San Francisco, CA (US)

(72) Inventors: Johan Backman, San Francisco, CA (US); Laurence Duggan, San Francisco, CA (US)

(21) Appl. No.: 18/807,839

(22) Filed: Aug. 16, 2024

(51) Int. Cl. G06Q 20/40; G06Q 20/10

(52) U.S. Cl. CPC G06Q 20/405; G06Q 20/10

(57) ABSTRACT

A method for facilitating minimization of fees charged to customers with respect to electronic fund transfers associated with transactions may include receiving, by a facilitation agent, account transaction data associated with transactions initiated with respect to a plurality of customer accounts, employing a machine learning platform to identify fee charges in the account transaction data, employing the machine learning platform to determine a fee profile for the identified fee charges, the fee profile including a potential cause for each of the identified fee charges, employing the machine learning platform to define a settlement path to minimize a likelihood of triggering a fee for a given customer account associated with a transaction based on avoidance of the potential cause for each of the identified fee charges, and updating a settlement model based on the settlement path.

### TECHNICAL FIELD

Example embodiments generally relate to financial industry technologies and, in particular, relate to apparatuses, systems, and methods for providing technical tools to monitor and act to avoid overdraft fees in connection with financial transactions.

### BACKGROUND

The financial industry comprises many thousands of customers, vendors, lenders, borrowers, and other role players that all interact in various ways to enable customers to ultimately have access to goods and services provided by vendors. Credit and financial transactions have long been a way that individuals have managed point of sale transactions to ensure seamless transfer of funds from customers, or on their behalf, to vendors for relatively routine or small transactions. Meanwhile, obtaining a loan from a bank has long been the most common way of obtaining financing for non-routine or larger transactions. More recently, installment loan financing has become a popular option.

Credit cards and certain other lending vehicles may be useful tools for many customers. However, some customers can find themselves over extended either quickly or over a period of time based on the existing tools. This phenomenon has repeated itself over generations, and for millions of customers. Thus, there is now a deep desire on the part of many to create flexible and fair means of supporting customer purchasing activities that is both honest and transparent, and that also improves the lives of customers.

Recently, many financial institutions have issued customers a payment card (e.g., a physical or virtual credit or debit card or other value card) to enable the customers to initiate transactions either supported by a customer account or linked to one or more loans. In many cases, the payment card may be linked to an account (e.g., a checking or savings account) that can be used to fund transactions via money transfers into or out of the account. The money transfers may include, for example, Automated Clearing House (ACH) transfers or payments among other electronic fund transfer vehicles.

ACH payments are a form of electronic bank transaction made using a network (i.e., the ACH network) that is formed from a system of computers that communicate with each other to make and receive payments. For each transaction there is one computer at the sending end to send a request for payment, and another computer at the receiving end to accept the request. Whereas many customers may imagine that a financial transaction somehow transfers money directly from their accounts into the corresponding accounts of merchants, that is typically not the case. Instead, the card issuer or related entity (as described in more detail below) may transfer money from an account on behalf of the customer to the vendor to support the transaction, and then the card issuer may request an ACH transfer from the customer account to cover the transaction.

Although fairly standard as a method of transferring money, the movement of the money using ACH is relatively slow. In this regard, a lender or bank or related finance company may submit a file containing all of the transfers that are to be performed to initiate the process, but there is generally no confirmation received through the system to indicate whether or not each transaction has gone through successfully. The only communication received from the system is generally received in the event of a failure for either insufficient funds or an account being closed, for example. Moreover, even notifications of failed ACH transfers may take 1 to 2 business days to be received.

The fact that there is no confirmation for successful transfers can create a problem for a card user (and consequently for a card issuer) since it is not clear what the current status of the user (or customer) account(s) may be at the time a transaction needs to be made. The card issuer must therefore balance the risk of floating money to a customer against the uncertainty of the accuracy of account information. Should the card issuer decide to take the risk in a situation where the customer has had intervening transactions taking money from his/her account that causes an ACH transfer to fail, both the customer and the card issuer may receive financial penalties in the form of failed transfer fees.

In at least some cases, these fees may be avoidable, and such avoidance is highly desirable for the customer and the card issuer (since they only benefit the bank charging the fee). The persistence of such a desirable problem to eliminate exists due to the fact that there are presently no technical means to be sure that perfect information on account status is being reviewed when decisions are being made. While that level of perfection is not likely to be achieved in the short term, and until such a solution can be provided, perhaps other technical means may be instantiated to alleviate the problem noted above. Example embodiments aim precisely at doing this.

As can likely be appreciated from the description above, the potential for receiving failed ACH transfer notification can be very frustrating and costly for users. Moreover, causing user frustration can dissuade users from establishing loyalty to any particular brand or service. Given that the nature of ACH transfers is outside the control of the card issuer (or lender), the card issuer or lender must consider other creative options for improving the situation described above that are fully within the control of the card issuer or lender. Accordingly, some example embodiments may enable the provision of technical means by which to provide a more trustworthy and accurate way to handle transactions involving account status determinations and ACH payments to set up a system that prevents ACH transfer overdraft fees from impacting the customer. Moreover, example embodiments may apply to such fee avoidance in other electronic funds transfer contexts, which may further benefit the customer and foster loyalty and satisfaction for the customer.

### BRIEF SUMMARY OF SOME EXAMPLES

In an example embodiment, a method for facilitating minimization of fees charged to customers with respect to electronic fund transfers associated with transactions may include receiving, by a facilitation agent, account transaction data associated with transactions initiated with respect to a plurality of customer accounts, employing a machine learning platform to identify fee charges in the account transaction data, employing the machine learning platform to determine a fee profile for the identified fee charges, the fee profile including a potential cause for each of the identified fee charges, employing the machine learning platform to define a settlement path to minimize a likelihood of triggering a fee for a given customer account associated with a transaction based on avoidance of the potential cause for each of the identified fee charges, and updating a settlement model based on the settlement path.

In another example embodiment, an apparatus for facilitating minimization of fees charged to customers with respect to electronic fund transfers associated with transactions may be provided. The apparatus may include processing circuitry configured for receiving, by a facilitation agent, account transaction data associated with transactions initiated with respect to a plurality of customer accounts, employing a machine learning platform to identify fee charges in the account transaction data, employing the machine learning platform to determine a fee profile for the identified fee charges, the fee profile including a potential cause for each of the identified fee charges, employing the machine learning platform to define a settlement path to minimize a likelihood of triggering a fee for a given customer account associated with a transaction based on avoidance of the potential cause for each of the identified fee charges, and updating a settlement model based on the settlement path.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for preventing or minimizing charging of fees to customers for settlement of transactions according to an example embodiment;

FIG. 2 illustrates a functional block diagram of a payments platform according to an example embodiment;

FIG. 3 illustrates a block diagram showing control flow associated with transaction settlement flow in accordance with an example embodiment;

FIG. 4 illustrates a block diagram showing system interactions in accordance with an example embodiment; and

FIG. 5 illustrates a block diagram of a method for facilitating minimization of fee generation for customers associated with electronic funds transfers for transactions in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

In today's world, the relationship between a lender or creditor and a borrower is sometimes experienced by the borrower as being a one-sided relationship. High fees for successful or failed transactions, and high interest rates can sometimes be charged to borrowers, and make them feel an adversarial relationship with their lenders/creditors. However, successful and even long term or loyal relationships can be established between borrowers and lenders if the relationship is centered on activities that are mutually beneficial, thereby defining a win-win scenario. Particularly when the borrower can see and appreciate the benefit to themselves, their relationship with the lender/creditor may be strengthened.

In the recent past, technological tools have been employed to enable lenders/creditors to define ways to maximize the likelihood that the lender/creditor gets paid back by the borrower, or maximize the profit made on payments received from the borrower. However, if that focus were shifted slightly, to instead a focus on avoiding the issuance of fees imposed on the borrower, the borrower would undoubtedly benefit. The benefit to the borrower in terms of saving money is obvious. But the lender/creditor may also benefit through increased loyalty and increased transaction volume as time goes on, thereby creating the potential for a win-win scenario.

In light of the discussion above, it should also be understood that the lender/creditor is sometimes, but not always, also the facilitator of the transaction forming the basis for the lending/borrowing relationship. The facilitator of the transaction may therefore be, for example, a card manager in the case of a virtual or physical credit or debit card (e.g., a payment card). However, regardless of whether the facilitator is the lender or not, the facilitator often plays a unique and interesting role in the lender/borrower relationship. In this regard, borrowers have significant options they can exercise in relation to the payment vehicle they choose to use for transactions. Which card they pull from their physical or virtual wallet to use for funding a transaction is an important decision to the transaction facilitators in the marketplace. Causing the borrower to favor your business as his/her payment vehicle of choice is therefore a powerful incentive. Having borrowers come to know that your business has the technical tools, and the organizational focus, to employ those tools to their benefit, may therefore be a significant driver of transaction volume and customer loyalty.

This brings us to the technical tools themselves. For many payment facilitators (who may or may not also be lenders), computer systems are defined that employ mathematical models to power decision-making with respect to approving or denying a transaction that is attempted for a payment card. The financial bottom line may therefore often depend directly on the accuracy of the model with respect to predicting whether the funding of the transaction is above or below some risk threshold associated with the likelihood of getting paid back. Thus, the financial industry is often focused on developing strong models for predicting risk of default on loan repayment that tend to categorize or consider very strongly the behavior of the borrower. If the desired outcome is not merely making a binary choice regarding whether to deny or accept a transaction based on information about the borrower to minimize risk, but instead further on handling the transaction via a pathway that avoids or minimizes fees that will be incurred by the customer (borrower), the complexity of the mathematical problem involved skyrockets because it becomes necessary to consider the behavior of the banks or lenders involved in the transaction (not just for this customer, but in the aggregate) must also be considered. Moreover, these decisions must be made in very short periods of time.

Accordingly, example embodiments may employ machine learning tools that operate on massive amounts of data to continuously learn and update models associated with defining payment processing pathways to avoid or minimize fees incurred by the transaction that will be passed on to the customer. In this regard, as a payment facilitator that facilitates payments for a multitude of customers that each have their own respective banks and accounts that are associated with different payment vehicles, the facilitator has an interesting and potentially useful view of the results of various electronic fund transfer events. However, the view is a confused and chaotic view that includes vast numbers of differently formatted signals of sometimes unknown and perhaps inconsistent meaning.

Example embodiments may therefore define and employ a robust machine learning (ML) platform operated by a facilitator, positioned to monitor the activity (i.e., signals) being witnessed for patterns indicative of fees charged to, or activities associated with fees that will be charged to, customers in association with processing a transaction. The ML platform may include or be in communication with a transaction settlement model that defines settlement flow for transactions thereby dictating the timing and execution of various activities associated with settlement of each transaction initiated with an electronic funds transfer. The settlement model may be used by a settlement agent to define the actions taken in association with settling transactions (i.e., a settlement algorithm).

The ML platform may also include a fee identification engine that monitors settlement activity over time for multitudes of transactions and therefore multitudes of customers and their respective accounts (at various banks). The fee identification engine may search for patterns in signals (as noted above, which are often in various different and potentially unstructured formats) that indicate that a fee has been charged to a customer. The fee identification engine may also be configured to determine what specific activities associated with transaction settlement seem to be associated with, and perhaps cause, the assessment of fees for a given account (and potentially therefore also for a given bank or institution). The fee identification engine may therefore define a fee profile for respective different entities (e.g., banks, accounts, customers, etc.) that can then be used by a fee avoidance engine to define a settlement path that minimizes the likelihood of triggering a fee for the customer. The fee profile for some banks, accounts or customers may therefore indicate, for example, a tendency or propensity for incurring fees. Given the fee profile, example embodiments may alternatively or additionally inform or educate the customer regarding the likelihood of incurring fees and perhaps alternative steps that can be taken to avoid fees (such as using other banks or accounts).

Of note, with respect to the components described above (e.g., the fee identification engine, and the fee avoidance engine), each component may employ respective models that are updated continuously and automatically via machine learning employed by the ML platform 70. Thus, for example, machine learning may be employed for defining a model updating engine that continuously learns on the massive volumes of real time data that are being monitored. The model updating engine may work specifically to strengthen the models by ranking the strength of certain signals or signal patterns that are encountered or employed for each of the models. In this regard, the strongest signals and patterns may therefore be relied upon most heavily with respect to each model being employed. The model updating engine may specifically, in some cases, be configured to update the settlement model based on the settlement path defined by the fee avoidance engine based on the fee profile.

Some example embodiments described herein provide for a payments platform that can be instantiated at an apparatus comprising configurable processing circuitry, and which may process various pay now, credit, debit, or other financial transactions involving electronic funds transfer. The processing circuitry may be configured to execute various processing functions on financial data using the techniques described herein. The payments platform may, for example, be configured to provide a way to determine, for an individual user, for individual banks, and even sometimes on a product-level basis, whether fees will be likely to be incurred for electronic fee transfers associated with settlement of a financial transaction. Thus, for example, a prediction of whether a fee is likely may be made using technical tools provided by example embodiments.

Example embodiments therefore use technical means embedded into information exchange, to further enable technical computation or calculation that improves the entire process massively (e.g., by avoiding otherwise avoidable fees). This technical assistance to customers, which saves both them and the transaction facilitator money and reputation, may be game changing in terms of customer satisfaction while also driving increased sales volume, without a corresponding appreciable increase in risk. The user can therefore experience the benefits of continued positive (e.g., relationship enhancing) behaviors, and the card issuer/transaction facilitator can build a loyal customer base of satisfied card users by using technical means to leverage benefit to the customer. Moreover, whereas the technical tools are ultimately used to avoid a fee, as will be outlined in greater detail below, the real technical challenge that is ultimately solved by example embodiments is to wade through a morass of complicated and unstructured signaling from many different organizations, and determine from that mass of information a profile for a bank, customer or product that relates to charging fees, so that those fees can later be avoided. Whereas strategies for avoiding fees may themselves be executed by a general purpose computer, the identification of fees charged so that what caused them can be determined is impossible in today's environment without the additional powerful machine learning tools described herein.

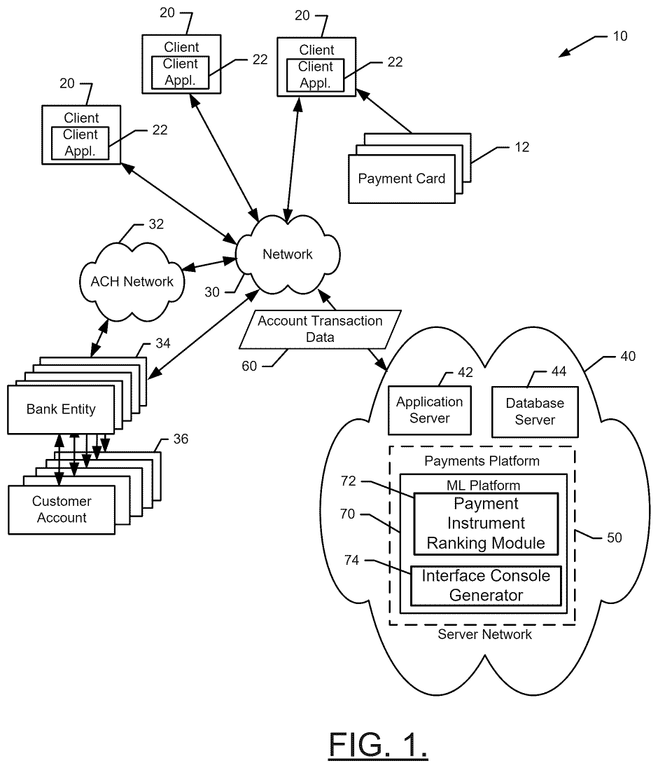

An example embodiment of the invention will now be described in reference to FIG. 1, which illustrates an example system in which an embodiment of the present invention may be employed. As shown in FIG. 1, a transaction management system 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The clients 20 may, in some cases, each be associated with a single computer or computing device that is capable of executing software programmed to implement example embodiments. Thus, in some embodiments, one or more of the clients 20 may be associated with an organization (e.g., a merchant company) and may be located in different business units, branch offices, or other locations. In other cases, the clients 20 may be associated with individual users (i.e., customers) that may wish to interact with other clients 20 and/or a financial institution or entity. In general, the clients 20 may be terminals or platform entities that are capable of executing example embodiments, and there could be as few as one, or a host of such terminals or entities.

In one example use case, the client 20 may be a merchant terminal used to inform a payments platform 50 of a transaction initiated by a customer with the merchant via a payment card 12 (e.g., a credit or debit card) issued by or serviced by the borrower or facilitator. In another example use case, the client 20 may be a cell phone or computer of the customer attempting to initiate a transaction online to purchase a good or service provided by the merchant, and the client application 22 may be a website of the merchant via which the customer provides the payment card 12 or other payment method details to apply for credit from the borrower or facilitator via the payments platform. Example embodiments may, in some cases, specifically apply to financial transactions that involve electronic funds transfers.

Thus, for example, in some cases each one of the clients 20 may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, the network 30 may include or also be operably coupled to an automated clearing house (ACH) network 32 to which one or more instances of a bank entity 34 are also operably coupled. The bank entity 34 (or each of multiple such entities) may include various bank accounts associated with various customers. Such bank accounts may be referred to as customer accounts and customer account 36 in FIG. 1 is one such example of these customer accounts. As noted above, the customer may initiate a financial transaction to purchase a good or service of a merchant. For a debit purchase, the merchant (or customer) may inform the payments platform 50 (or transaction facilitation platform) of the desired transaction so that the customer can arrange the borrower/facilitator to transfer funds to the merchant on his/her behalf to obtain the good or service (e.g., from a for the benefit of (FBO) account of the borrower), and then arrange to transfer funds from the customer account 36 to borrower (facilitator). This transfer of funds from the customer account 36 may occur via the ACH network 32 by provision of an ACH file (or request) submitted by the facilitator to the bank entity 34. The bank entity 34 processes the ACH request and, if sufficient funds are available in the customer account 36, transfers money in the amount of the transaction from the customer account 36 to the facilitator.

In an example embodiment, devices to which the clients 20 may be coupled via the network 30 may include one or more application servers (e.g., application server 42), and/or a database server 44, which together may form respective elements of a server network 40. Although the application server 42 and the database server 44 are each referred to as “servers,” this does not necessarily imply that they are embodied on separate servers or devices. As such, for example, a single server or device may include both entities and the database server 44 could merely be represented by a database or group of databases physically located on the same server or device as the application server 42. The application server 42 and the database server 44 may include hardware and/or software for configuring the application server 42 and the database server 44, respectively, to perform various functions. As such, for example, the application server 42 may include processing logic and memory enabling the application server 42 to access and/or execute stored computer readable instructions for performing various functions. In an example embodiment, one function that may be provided by the application server 42 may be the provision of access to information and/or services related to payments platform 50, and more particularly relating to facilitating financial computations and calculations related to decisions associated with extensions of credit (e.g., to cover financial transactions). For example, the application server 42 may be configured to provide (via the payments platform 50) execution of instructions, and storage of information descriptive of events or activities, associated with the payments platform 50 and the execution of a financial computations, calculations and modeling on behalf of a user of the system 10 located at one of the clients 20, or interacting with a user located at one of the clients 20, in real time.

In some cases, the financial transaction may include obtaining temporary funds transfer servicing associated with financial transactions, and the activities associated therewith may include the provision of a debit card or account number that can be used to facilitate financial transactions detailing information required by the facilitator (and operator of the payments platform 50) to determine whether credit, funds, or other products can be provided to the customer based on information provided. In some cases, the information provided may be provided by the customer. However, in others, the bank entity 34 may be contacted to determine a status of the customer account 36 (e.g., an account balance therein) to determine how much can safely be advanced on behalf of the customer to support financial transactions.

In some embodiments, the payments platform 50 may be a technical device, component or module affiliated with the lender or an agent of the lender. Thus, the payments platform 50 may operate under control of the lender or agent of the lender to be a technical means by which to carry out activities under direction of the lender/agent or employees thereof. The lender may, in some cases, be a facilitator of a transaction between the user (or customer) and a merchant, where such facilitation includes the advancement of funds, provision of a loan or extension of credit to the customer (thereby making the customer a borrower, and the facilitator a lender). The facilitator may, in effect, act via the operation of the payments platform 50 via configuration of various decision making components thereof. Thus, in some cases, the payments platform 50 may effectively act as a facilitation agent.

In some embodiments, the clients 20 may access the payments platform 50 services, and more particularly contact the payments platform 50 online and utilize the services provided thereby. However, it should be appreciated that in other embodiments, an application (e.g., the client application 22) enabling the clients 20 to interact with the payments platform 50 (or components thereof) may be provided from the application server 42 (e.g., via download over the network 30) to one or more of the clients 20 to enable recipient clients 20 to instantiate an instance of the client application 22 for local operation such that the payments platform 50 may be a distributor of software enabling individual users to utilize the payments platform 50. Alternatively, another distributor of the software may provide the client 20 with the client application 22, and the payments platform 50 may communicate with the client 20 (via the client application 22) after such download.

In an example embodiment, the client application 22 may therefore include application programming interfaces (APIs) and other web interfaces to enable the client 20 to conduct operations as described herein via the payments platform 50. The client application 22 may include a series of control consoles or web pages including a landing page, onboarding services, activity feed, account settings (e.g., user profile information), transaction management services, payment management services and the like in cooperation with a service application that may be executed at the payments platform 50. Thus, for example, the client application 22 may enable the user or operator to articulate and submit queries, make credit extension requests, initiate and pay for transactions using funds associated with a credit extension request, and/or the like using the payments platform 50.

In an example embodiment, the application server 42 may include or have access to memory (e.g., internal memory or the database server 44) for storing instructions or applications for the performance of various functions and a corresponding processor for executing stored instructions or applications. For example, the memory may store an instance of the payments platform 50 configured to operate in accordance with an example embodiment of the present invention. In this regard, for example, the payments platform 50 may include software for enabling the application server 42 to communicate with the network 30 and/or the clients 20 for the provision and/or receipt of information associated with performing activities as described herein. Moreover, in some embodiments, the application server 42 may include or otherwise be in communication with an access terminal such as any one of the clients 20 (e.g., a computer including a user interface) via which individual operators or managers of the entity associated with the facilitation agent may interact with, configure or otherwise maintain the payments platform 50. Thus, it should be appreciated that the functions of the payments platform 50 can be conducted via client-server based interactions involving communications between clients 20 and the server network 40, or may be conducted locally at one of the clients 20 after an instance of the payments platform 50 is downloaded (e.g., via or as the client application 22) locally at the corresponding one of the clients 20.

As such, the environment of FIG. 1 illustrates an example in which provision of content and information associated with the financial industry may be accomplished by a particular entity (namely the payments platform 50 residing at the application server 42 or at one of the clients 20). Thus, the payments platform 50 may be configured to handle provision of content and information that are secured as appropriate for the individuals or organizations involved and credentials of individuals or organizations attempting to utilize the tools provided herein may be managed by digital rights management services or other authentication and security services or protocols that are outside the scope of this disclosure.

As noted above, the payments platform 50 may operate to enable the user associated with a given one of the clients 20 to setup an account (i.e., a user account) with an entity (e.g., a lender or facilitator) that operates the payments platform 50 and that, in some cases, may issue, or partner with an issuer of, the payment card 12 to the customer. The user account may be specific to one user (or customer) and may be accessed by the user via the user's respective instance of the client application 22. After account setup, the user may initiate transactions with various merchants via a physical or virtual card supported by the entity in association with the user account. The user account may, in some cases, be linked to the customer account 36 to facilitate access by the facilitator to the customer account 36 in association with conducting financial transactions. In this context, for example, the amount of money in the customer account 36 may be used by the facilitator to determine if a financial transaction initiated by the user associated with the user account is approved or denied by the facilitator. If the transaction is approved, the facilitator may then initiate an ACH pull in order to be reimbursed from the funds in the customer account 36. However, it should be appreciated that ACH is merely one example of an electronic funds transfer to which example embodiments may apply. Thus, the ACH network 32 may be replaced by any electronic funds transfer network in other examples.

In a typical case, the facilitator may be enabled to get a report from the bank entity 34 as to the status of the customer account 36 periodically. For example, upon request or at various intervals, the facilitator may receive an account balance or other status information associated with the customer account 36. Obviously, the facilitator would not want to cover a transaction larger than the current account balance in the customer account 36. However, there remains the problem that the facilitator cannot know in real time what other transaction or money transfers are planned or already being processed that may add money into or take money from the customer account 36. Thus, the facilitator must appreciate that the account balance fluctuates.

In some cases, to account for this natural and normal fluctuation of the account balance of the customer account 36, the facilitator may place a predetermined transaction limit as a function of the account balance at any given time to define a limit to the exposure risk the facilitator is willing to accept. For example, the predetermined transaction limit may be 80% of the account balance at the time the account balance is checked (although any suitable value reflecting the risk tolerance of the facilitator may be chosen). In such a case, similar to the example discussed above, if the customer has $500 as the account balance in the customer account 36, the facilitator may allow the customer to conduct transactions supported by the facilitator in the amount of $400 (i.e., 80% of $500). If the customer employs the payment card 12 (e.g., debit card) or otherwise attempts a transaction online in the amount of $300, the facilitator may approve the transaction and transfer funds to the corresponding merchant accordingly. The facilitator may also generate an ACH file to request transfer of $300 from the customer account 36 to the facilitator to cover or settle the transaction. However, as noted above, ACH transactions may take days to be completely resolved, and it is possible that the customer account 36 may have other transfers out scheduled ahead of the transaction which, if executed, may leave the customer account 36 short of funds when the ACH pull request arrives. Thus, for example, if another transaction or series of transactions were conducted before processing of the ACH request for $300, and the other transaction or series of transactions leave less than $300 remaining in the customer account 36, this situation would result in an insufficient funds notification (NSF return) being sent to the facilitator, and the facilitator would not receive (at least at this time) the money needed to settle the transaction.

In addition to the facilitator having to deal with receipt of the insufficient funds notification, the user or customer associated with the customer account 36 may receive an overdraft fee from his/her bank (e.g., the bank entity 34). In order to guard against this, and potentially other fees that may be associated with various transactions whether supported by ACH or not, particularly with respect to subsequent transactions the customer may attempt to engage in, the facilitator may analyze via request and/or receipt of status update information associated with not only the customer account 36, but a multitude of customer accounts associated with this an many other customers, also covering many bank entities and other organizations, to attempt to determine which settlement activities that the facilitator may engage in are more likely to generate fees (and what magnitude of fees) for the user or customer associated with the customer account 36. Moreover, the facilitator may change settlement activities and strategies going forward to attempt to minimize fees levied on the user or customer associated with the customer account 36. To do this at scale (i.e., for many thousands or even millions of customers) entails a massive computational load that, especially given the real time nature of decisions being made in this context, is far beyond the capabilities of typical computers or servers. Accordingly, the payments platform 50 may employ machine learning (e.g., via ML platform 70) to handle the massive computational load in a real time environment.

The status update information mentioned above may be obtained by the payments platform 70 via the network 30. The account transaction data 60 may include frequent account updates from the bank entity 34 that may extend beyond those that are otherwise necessitated by individual transactions or routine periodic checks. These more frequent account updates (e.g., status update information) may be provided in the form of account transaction data 60 as shown in FIG. 1. The facilitator may also utilize profile information or other local knowledge retained about the customer and/or the customer account 36, which may form part of the status update information, in some cases. Based on the status update information (e.g., the account transaction data 60 and any profile information or local knowledge), the payments platform 50 may utilize the ML platform 70 to determine how to minimize fee generation associated with each attempted transaction (or candidate transaction) that is undertaken with the payment card 12 or via any other payment vehicle that may result in an ACH or other electronic money transfer.

The challenge of processing the massive computational load mentioned above is only further complicated by the fact that the status update information within the account transaction data 60 is generally unformatted data. In this regard, for example, the status update information may come in any number of forms of characters and signals that are received from the ACH network 32, from client applications 22, from bank entities 34, and/or the like. The signals include many millions of characters and sequences that may, in some cases, be indicative of fees charged to the customer. The goal of the ML platform 70 is to learn how to monitor this massive volume of information and learn how to spot patterns that can fairly be assumed (and hopefully over time confirmed) to be associated with fees, so that the settlement activities that may have driven the generation of such fees can be modified or throttled to avoid future fee generation for the customer(s).

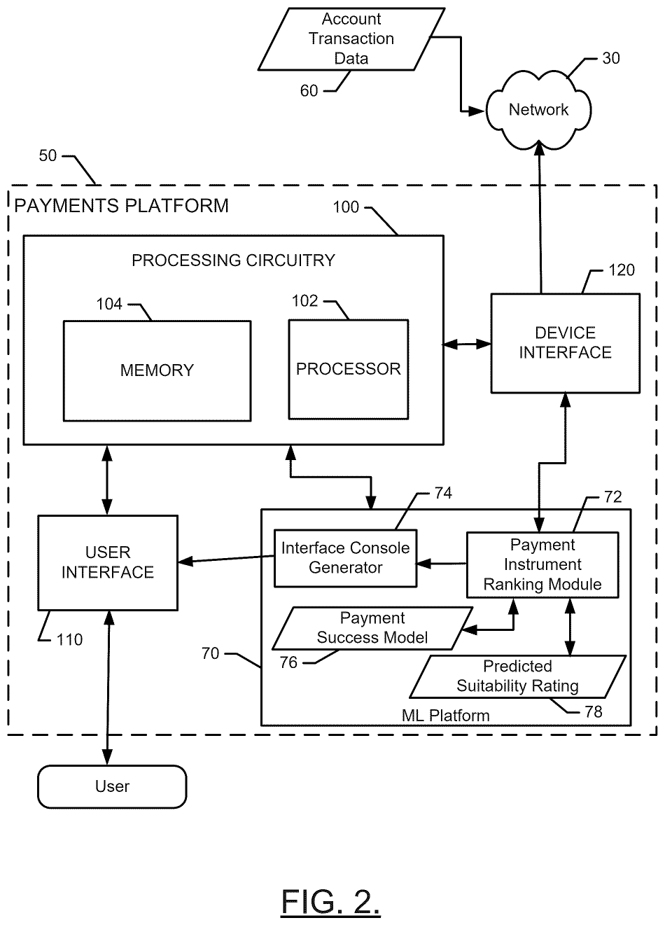

The payments platform 50 (and/or the ML platform 70) may also include a number of components or modules that assist in various aspects of processing the massive volumes of unstructured data and signals mentioned above. For example, the payments platform (and/or the ML platform 70) may include a fee identification engine 72, a fee avoidance engine 74, and a model updating engine 76. Each of these additional components or modules may be integral portions or modules of the payments platform 50 (and/or the ML platform 70), or may be called by the payments platform 50 (and/or the ML platform 70) to perform their respective functions (e.g., via API or other programming calls), or vice versa. Thus, for example, the fee identification engine 72 may include modeling, algorithms, or instructions that enable the fee identification engine 72 to call the ML platform 70 to apply machine learning to the identification of fees in the unstructured signals of the status update information. Similarly, the fee avoidance engine 74 may include modeling, algorithms, or instructions that enable the fee avoidance engine 74 to call the ML platform 70 to apply machine learning to the identification of potential settlement paths that may avoid generation of fees based on the fees identified by the fee identification engine 72. Also, the model updating engine 76 may include modeling, algorithms, or instructions that enable the fee model updating engine 76 to call the ML platform 70 to apply machine learning to the updating of the settlement models used to settle transactions. More details about the interactions of these components will be discussed below in reference to FIG. 2.

FIG. 2 shows certain elements of an apparatus for provision of the payments platform 50 or other processing circuitry according to an example embodiment. The apparatus of FIG. 2 may be employed, for example, as the payments platform 50 operating at, for example, a network device, server, proxy, or the like (e.g., the application server 42 or client 20 of FIG. 1)). Alternatively, embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 42 or the client 20) or by devices in a client/server relationship (e.g., the application server 42 and one or more clients 20). Thus, although FIG. 2 illustrates the payments platform 50 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating decision making regarding support for financial transactions (e.g., credit, debit, etc.) supported by the technical improvements of an example embodiment is shown. In this regard, the payments platform 50 may be configured to perform analysis, modeling, or other determinations based on the signaling and/or the information provided to determine whether to facilitate a financial transaction on behalf of a customer and, if so, conduct the corresponding transfers of money needed to do so in such a way that is aimed at avoiding the generation of fees for the customer when the transaction is being settled. The apparatus may be an embodiment of the payments platform 50 or a device or component thereof including, for example, the ML platform 70 or its respective modules, engines or components. As such, configuration of the apparatus as described herein may transform the apparatus into the payments platform 50. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In some embodiments, the processor 102 may be embodied as a central processing unit (CPU) or a graphics processing unit (GPU). In situations where the processing circuitry 100 is embodied as a server or at a remotely located computing device, the user interface 110 may be disposed at another device (e.g., at a computer terminal) that may be in communication with the processing circuitry 100 via the device interface 120 and/or a network (e.g., network 30). Thus, in some cases, the connection of the user to the user interface 110 may actually occur via the network 30.

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, the user interface 110 may be remotely located.

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 44) that may store a variety of files, contents or data sets. Among the contents of the memory 104, applications (e.g., a service application configured to interface with the client application 22) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the payments platform 50, the ML platform 70, and/or any of the modules listed above (e.g., the fee identification engine 72, the fee avoidance engine 74 and the model updating engine 76) each of which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the payments platform 50, the ML platform 70, the fee identification engine 72, the fee avoidance engine 74 and the model updating engine 76 as described below.

The ML platform 70 may employ one or more instances of a neural network (e.g., a CNN), a support vector machine (SVM), Bayesian network, logistic regression, logistic classification, decision tree, ensemble classifier or other machine learning model to process inputs received by the ML platform 70 to generate outputs as described herein. The ML platform 70 may be supervised (identifying patterns in raw data upon which inference processes are desired to be performed via training examples) or unsupervised (identifying patterns in raw data upon which inference processes are desired to be performed without training examples). In an example embodiment, the ML platform 70 may include a neural network of nodes where each node includes input values, a set of weights, and an activation function. The neural network node may calculate the activation function on the input values to produce an output value. The activation function may be a non-linear function computed on the weighted sum of the input values plus an optional constant. Neural network nodes may be connected to each other such that the output of one node is the input of another node. Moreover, neural network nodes may be organized into layers, each layer comprising one or more nodes. The neural network may be trained and update its internal parameters via backpropagation during training. A CNN may be a type of neural network that further adds one or more convolutional filters (e.g., kernels) that operate on the outputs of the preceding neural network layer to produce and output to then next layer. The convolutional filters may have a window in which they operate, which is spatially local. A node of a preceding layer may be connected to a node in the current layer if the node of the preceding layer is within the window. If not within the window, then the nodes are not connected.

In an example embodiment, training may occur via the provision of training data along with target data that includes desired output data associated achieved from the training data via respective models stored in the memory 104 and accessible to the ML platform 70. Thereafter, when inferences are to be drawn with respect to a new set of data including new information to provide an output that is indicative of options for output, training backpropagation may be provided to update the learning. The information provided to the ML platform 70, and the corresponding outputs to be gained therefrom, may vary. Thus, for example, the ML platform 70 may, in some cases, be employed by the fee identification engine 72 to enhance fee identification performance. In such cases, for example, massive amounts of real time account activity across a multitude of instances of the customer account 36 may be simultaneously monitored. Specific potential instances of fee charging may be detectable in real time, whereas others may only be detectable by monitoring patterns that play out over longer periods of time. The ML platform 70 may assist in load balancing between real time fee detection and post hoc fee detection of the the fee identification engine 72. As such, the load balancing function may effectively triage massive amounts of data into respective camps that dictate how quickly fee detection resources are to be employed for detecting fee charging activity. In such capacity, the machine learning module of the ML platform 70 may not only conduct load balancing, but may schedule individual fee monitoring activities at specific future times during which resources for fee detection are expected to be available for the corresponding type or priority of data being analyzed for fee charging activity.

Specifically with respect to fee identification, patterns that can be detected by the fee identification engine 72 may include searches for known fee codes or signals, and for known fee amounts in a given range of values that are known to correspond to typical fee charges. In this regard, for example, for many organizations, fees charged may be in the range of $20 to $80, with $35 being a very common fee charge. In some cases, the fee identification engine 72 may further associate specific fee amounts with corresponding entities (e.g., banks) that are known to charge the specific fee amount. Thus, for example, the ML platform 70 may be trained to identify that Acme bank tends to charge insufficient fund return fees of $35, whereas Beta bank may charge a similar fee of $40. The ML platform 70 may cooperate with the fee identification engine 72 to ensure that for transactions associated with Acme bank, any apparent fees of $35 are strongly weighted to be considered to be fee charges that are desirably to be avoided (and therefore require action by the fee avoidance engine 74. Meanwhile, for any transactions associated with Beta bank, similar weighting may be provided to any possible fee charges at $40. By these means, higher confidence that a fee has been charged may be obtained, and the actions of the fee avoidance engine 74 and the model updating engine 76 may be initiated.

Another example pattern that may be used for fee detection may be the temporal proximity of an apparent dollar value amount charged, or at least associated with an amount involved in a transaction, to the transaction. Thus, for example, if Acme bank is known to charge its insufficient fund return fees within a same business day as a transaction, any potential fee that falls on the same business day as a transaction may be weighted by the ML platform 70 for more likely identification as an actual fee that should be avoided (thereby triggering action from the fee avoidance engine 74 and the model updating engine 76). However, a potential fee hitting three days after the last transaction may be weighted very lightly, and therefore may not trigger action from the fee avoidance engine 74 and the model updating engine 76. Meanwhile, if Beta bank is known to (or can be learned to) charge its insufficient fund return fees in a range of two to three business days after a transaction, the weighting of potential fees by the ML platform and fee identification engine 72 may be handled accordingly.

Still another example of pattern detection upon which the ML platform 70 may be trained may include a text component or naming convention used for a fee string. Thus, for example, if Acme bank is known to (or can be learned) to preface or otherwise associate its fee charges with a given text string or name, the corresponding text string or name may be learned and any numerical value associated with the learned text string or name can be identified by the fee identification engine 72 as being a potential fee that may be desirable to avoid.

Accordingly, training data used for training of the fee identification engine 72 may be selected based on its inclusion of known fees from ad hoc analysis. However, in some cases, the facilitator may use data relating to situations where the facilitator is aware that its own actions caused the generation of a fee. In fact, these situations may present the strongest training data since the existence of an actual fee may be known and therefore examination of text strings, temporal factors, and dollar amounts charged may all be conducted with the full assurance that an actual fee was charged, so maximum weight can be given to the training example, and any correlations to similar patterns or situations detected in the future.

In some cases, the information learned about a particular bank or other entity may be used to define a fee profile that may be used by the fee identification engine 72 and/or the ML platform 70 for any customer account 36 known to be associated with the bank or other entity to which the fee profile applies. The fee profile may have a validity ranking associated therewith, and the validity ranking may be determined based on an overall weight or strength of various factors tending to indicate the strength of correlations made for the corresponding bank or third party to fee generation behaviors. In some cases, the validity ranking may also have a temporal component relating to how recently the behaviors have been experienced. Moreover, in some cases, fee generation behaviors may be further specifically associated with individual products, divisions, of subsidiaries of a given bank or other entity. As the products are marketed and replaced by other products, the behaviors associated with earlier products may cease to be noted or may change with subsequent future products. Thus, the temporal aspect of validity ranking can ensure that old data does not dominate current fee identification strategies.

In a case where a training database is desired, identification of training data may be obtained by identifying situations with known fee charges, and studying the signals associated with the situations to build the training data set. Knowing which signals actually include known fees can be accomplished, as noted above, when the facilitator's own actions triggered the fee. However, for better learning, more comprehensive data sets may be desired. Surveys of customers or banks may be one way to obtain additional identifications of fees or fee generation scenarios. But surveys may be annoying to customers or banks, and participation may be spotty in any case. To obtain more data including reliable fee scenarios from which to train, the ML platform of an example embodiment may employ generative artificial intelligence (AI) to find public records, social media posts, message boards or other clues to situations or scenarios that generated fees. For example, social media posts may identify customer complaints or problem resolution records involving fees associated with data strings accessible to the facilitator and therefore usable for improving data sets via training. The more accurate training data can be with the littlest impact on customers and banks, the more desirable the result may be for the facilitator. The ML platform 70 may therefore be constructed and managed with those goals in mind.

In some embodiments, the fee avoidance engine 74 and/or the model updating engine 76 may leverage resources of the ML platform 70 for enhanced performance as well. In this regard, for example, the ML platform 70 may monitor continued performance of a settlement agent 130 employing a settlement model 132 for settlement transactions via monitoring of the account transaction data 60 by the fee identification engine 72 to determine whether the settlement model 132 being employed is effective at fee avoidance based on the strategy defined for fee avoidance by the fee avoidance engine 74 and corresponding model updating by the model updating engine 76. The fee avoidance engine 74 can receive feedback that informs (via machine learning) the fee avoidance engine 74 regarding its own effectiveness at avoiding fees. Any changes in strategy may be communicated to the model updating engine 76, and the settlement model 132 may be updated correspondingly.

In an example embodiment, the ML platform 70 may offer the customer and/or merchants opportunities to enhance the data and learning by providing feedback. In either case, confirmation of a fee charge (including the amount) may be requested from the customer or merchant. If confirmed, the confirmation may be used to identify a scenario that should be considered for updating of the training data or otherwise improving machine learned information gathering. Any associated models may also be updated to change weighting or validate scoring techniques as well.

As discussed above, the training data used to train the ML platform 70 may be selected by the facilitator ahead of time to include merchants, products, and categories thereof that are known by the facilitator through past experience to follow various known patterns with respect to fee generation. The known patterns may be used to build models that can infer relationships based on pieces of data that suggest the potential existence of the known patterns. However, every time a fee is charged, whether determined manually or automatically by the ML platform 70, or through input by the facilitator, merchants, or customers, the ML platform 70 and its respective models (e.g., category, customer, bank/merchant, or other entity specific models) may also be updated. Failures to identify fees may also train models, as negative instances of fee charging behaviors. Moreover, the ML platform 70 may also be trained to address other interactions with the customer that may enhance the customer experience so that, over time, the customer experience is continuously enhanced.

Regardless of the specific form of the ML platform 70, machine learning may be performed to perform inferences with respect to massively large volumes of data that would take normal computer processing very long periods of time to handle. The ML platform 70 can handle massive volumes of data, and identify the data pertinent to a given user, a given bank, a given situation or scenario, etc., within constraints that may be unique to the given user, bank, situation, etc., in the context of mountains of information, within seconds, whereas doing so with conventional processing tools (i.e., without machine learning) would take orders of magnitude longer periods of time. The ML platform 70 therefore enables an acceleration of the processing needed to conduct processing of data, but also to find deep patterns that are meaningful with respect to providing options that are most likely to be acceptable to the given user or situation within constraints that apply.

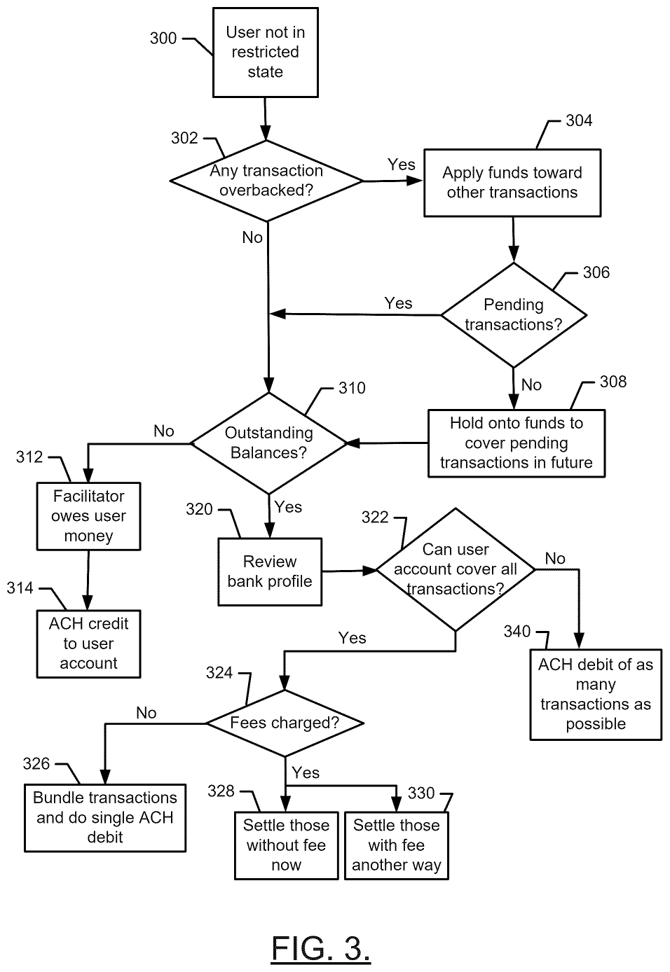

FIG. 3 illustrates a block diagram of an example of settlement flow according to an example embodiment. The settlement flow defined in FIG. 3 may be one example of operations dictated by the settlement agent 130 using the settlement model 132 of FIG. 2. As noted above, the settlement flow may, in some cases, trigger fee generation. Where possible to avoid such fee generation, the fee avoidance engine 74 may define strategies for fee avoidance (e.g., potential changes to the timing or actions associated with various aspects of the settlement flow), and the model updating engine 76 may be used to update the settlement model 132 accordingly, which may alter the settlement flow of FIG. 3 in some form.

As shown in FIG. 3, an initial state for settlement flow progression may be that the user (customer) is not in a restricted state at operation 300. The user may be in a restricted state if, for example, a predicted insufficient funds situation exists, or if funding is currently being held for the user for any reason. Thereafter, a determination may be made at operation 302 as to whether any transaction is overbacked or has an outstanding refund (i.e., too much funding—or the facilitator owes the user). If the transaction is overbacked (and money is owed to the user), then the overbacked funds may be applied to a subsequent transaction at operation 304. Thereafter, a determination may be made as to whether there are any pending transactions at operation 306. If there are pending transactions, the overbacked funds may be held onto in order to cover pending transactions in the future at operation 308. If the transaction is not overbacked at operation 302, or if there are no pending transactions at operation 306, flow may proceed to operation 310 at which time a determination is made as to whether the user has any outstanding balances.

If the result of operation 310 is that the user has not outstanding balances, then the facilitator may owe money to the user at operation 312, and an ACH credit may be provided to the user's bank account at operation 314. However, if the user has outstanding balances from the inquiry of operation 310, then the user's bank profile (including the fee profile discussed above) may be reviewed at operation 320. Thereafter, a determination may be made as to whether enough money is located in the user's account (e.g., customer account 36) to cover all outstanding transactions at operation 322. If there is enough, at operation 324 a determination may be made as to whether fees will likely be charged. If not, then all transactions outstanding may be bundled into a single ACH debit from the user's account (e.g., customer account 36) at operation 326. If fees may be charged, any transactions for which fees may be charged may be segregated and settled by debit from the user's account immediately at operation 328 and any fees that may be avoided may result in held payment or modified payment strategies at operation 330. If the result of operation 322 is that there is not enough money to cover all outstanding transactions, then as large a debit as is possible below a threshold for receiving a fee may be initiated. In some cases, debiting as much as possible may include an amount without regard to whether the amount matches to one or more whole transaction amounts. However, in other cases, for practical advantage, or due to system architecture or rule application, only whole transactions may be debited. In such an example, as many transactions as possible having transaction amounts below the threshold for receiving a fee may be initiated at operation 340.

Returning to the fee charge inquiry of operation 324, it may be appreciated that the operation of the ML platform 70 may facilitate the inclusion of this operation in what may otherwise be a relatively routine settlement flow. The earlier operation of the fee identification engine 72 may, especially after training and continued reinforcement through reinforced learning based on additional inputs, enable the accurate identification of banks that charge fees, and what those fees are, and when they are charged. Thus, operation 324 (which is actually executed by the settlement agent 130 and is structurally part of the settlement model 132) may be reliant on the ML platform 70. Meanwhile, the facilitator may employ the fee avoidance engine 74 to define alternative strategies for settlement that may avoid fee generation. The settlement of transactions likely to generate a fee by another way of operation 330 may include consideration of these alternative strategies. In this regard, the facilitator may be aware of other accounts of the user (e.g., other customer accounts with other banks), or the facilitator may have its own account with the user, and the facilitator may either settle a transaction with those accounts automatically (if access to do so is granted a priori by the user), or the facilitator may reach out to the user directly via messaging (e.g., email, SMS, in app messaging, etc.) to request access to other accounts that may enable settlement while avoiding fees. Thus, for example, the facilitator may send a message indicating that settlement via the customer account 36 may generate a fee and enable the user to authorize settlement by incurring the fee, or authorize use of another account that may be identified by the user or by the facilitator to settle the transaction and hopefully avoid any fec.

In some embodiments, the model updating engine 76 may be configured to interject messaging, account information, or other helpful actions associated with changing the settlement model 132 to reduce the likelihood that the user is charged a fee in association with settlement of any transaction. In association with determining likelihood of fees being charged, the payments platform 50 of some embodiments may employ a success predictor (e.g., embodied via the processing circuitry 100) that receives account transaction data 60 from the bank entity 34, and employs a scoring algorithm to determine whether a candidate transaction is likely to result in a successful withdrawal of funds from the customer account 36 in the amount of the candidate transaction and therefore avoid any NSF return or other fees. A success score may be issued as a probabilistic representation of how unlikely the candidate transaction is to result in an NSF return or other fee generating activity (and conversely how likely the candidate transaction is to result in a successful ACH transfer or electronic funds transfer). As can be appreciated from the descriptions above, the payments platform 50 may therefore desirably be upgraded by technical means to enable avoidance of NSF returns (or at least a reduction in frequency thereof), and corresponding fees, for both the customer and the facilitator.

In some example embodiments, the client application 22 may be used in connection with running queries, models, or calculations that are then used as the basis for interactions between the customer and merchants, and/or the lender/agent, or between decision makers within the organization in relation to services provided to customers, or policy decisions and budgeting that is to be done by the organization under control of the payments platform 50. In this regard, for example, the client application 22 may be used to engage (e.g., via a website and corresponding APIs) with the payments platform 50 to select individual products, financial transactions, loans, or types of loans to be evaluated using services associated with the payments platform 50. The payments platform 50 may prompt the client 20 to provide product or transaction details, or other information associated with the financial transaction that is being evaluated. In other words, the client 20 may provide a user interface function for interacting with the payments platform 50 to identify the information that will be evaluated using the payments platform 50.

Regardless of how the queries, calculations or modeling activities are initiated, the payments platform 50 of FIG. 1 may be used to manage execution of such activities. Each of these activities may have its own respective timing and calculations and communications that are facilitated by the payments platform 50 and various components of the payments platform 50 may be conducted in parallel. The components, which may be functional modules that operate via API or function calls to respective segmented platforms or a monolith or other collection of rules, policies, instructions, or the like. In an example embodiment, the payments platform 50 may include (or be operably coupled to) one or both of the ML platform 70 and various component modules described in reference to FIG. 2.

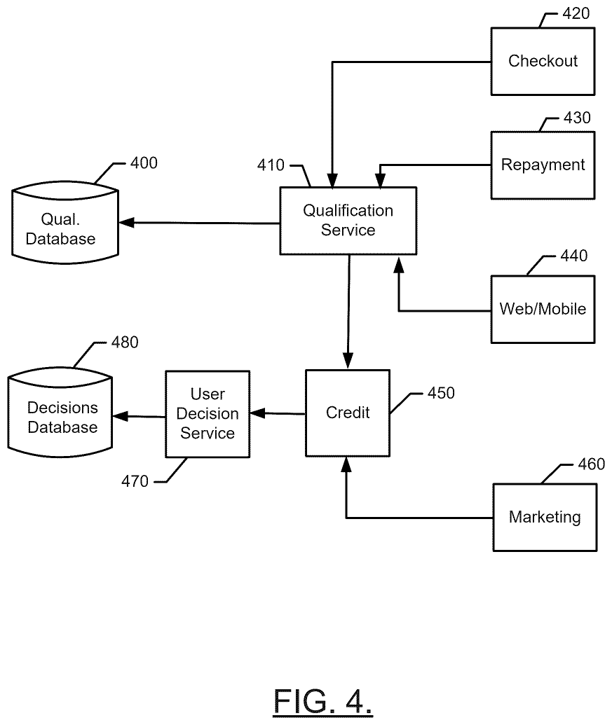

The method of FIG. 3 and the hardware described in reference to FIG. 2 are merely examples of methods and hardware that could be employed to implement example embodiments. Moreover, in some cases, various services or systems may cooperate to practice example embodiments, and different combinations of hardware and software may be employed to implement such services and systems. FIG. 4 is a block diagram of various systems interactions that may be employed to implement an early capture capability in accordance with an example embodiment.

As shown in FIG. 4, a qualification database 400 may store information associated with qualification of a plurality of users, each having a corresponding user account setup and maintained as described above. In an example embodiment, the qualification database 400 may be a portion of the database server 44 of FIG. 1, or implemented in memory 104 of FIG. 2. A qualification service 410 may interface with and update the qualification database 400. The qualification service 410 may be implemented from the payments platform 50.

Checkout information may be provided to the qualification service 410 by various checkout systems 420 associated with respective different vendors or websites. Repayment information may also be provided to the qualification service 410 by various repayment systems 430 associated with respective different vendors or websites. Web or mobile devices 440 may be examples of clients 20 that may interact with the qualification service 410 to setup user accounts and to initiate transactions (via the checkout systems 420) or may payments (via the repayment systems 430).

Credit system 450 may be employed to make credit extension decisions based on information from the qualification service 410, and to augment (or boost) credit limits based on marketing information from a marketing system 460, which may indicate when particular boosts, enhancements, or incentives for various merchants are applicable. A user decision service 470 may be used to consider early capture as described above in reference to operations 300 to 396 in FIG. 3. All information resulting from these decisions may be recorded in decisions database 480.

As can be appreciated from the description above, each user may be considered as a unique configuration (e.g., their terms with their bank may not match even for all users with the same bank). Therefore when fee activity can be detected, the fee profile may apply more specifically to certain aspects of the relationship with the bank rather than simply just to the bank. As such, the fee profile is a profile for the fee and the unique configuration in which it occurs, which can be learned about in greater detail than simply as the name of a bank. An understanding of the risk of incurring fees (i.e., the fee profile) may therefore be understood and learned to finer points of detail for each time a fee is detected and identified within the system. Thus, fee profiles may be discounted over time or as periods of time pass where they are not reinforced by additional instances of fee charges being detected. Example embodiments may also operate in concert with predictive tools to determine when it is likely that an insufficient funds return (NSF) will be encountered for ACH requests to further prevent fees and overdrafts. For example, an algorithm to predict NSF may be run and a certain percentage balance risk margin may be applied to reduce the customer's available balance by the certain percentage when determining how much credit to grant a customer.

Moreover, since example embodiments can identify when fees were charged, it is also possible that the facilitator can detect its own erroneous fee charges (or fee charges of others) and inform the customer. For its own errors, the facilitator may automatically initiate corrective fund transfers and let the customer know. The customer will undoubtedly appreciate the proactive correction, and the honesty. For fees charged by other entities, the customer may appreciate knowledge of the fee charged so the customer can dispute charges that may be erroneously charged by other institutions. In any case, as noted above, the machine learning module may improve the performance of the system over time by learning better pattern recognition to predict when accounts can successfully avoid NSF returns, and customer can avoid fees, when the ACH request is sent (for a selected amount or at a selected future time), or when other electronic fund transfers are attempted. Such minimization of fee charges may incentivize the user to continue to exhibit behaviors that lead to increases in user satisfaction, and brand loyalty while also increasing volume of transactions for the facilitator without an appreciable increase in risk. The corresponding incentives and rewards may ultimately provide a technical means by which to create a win/win relationship between the entity and the user.

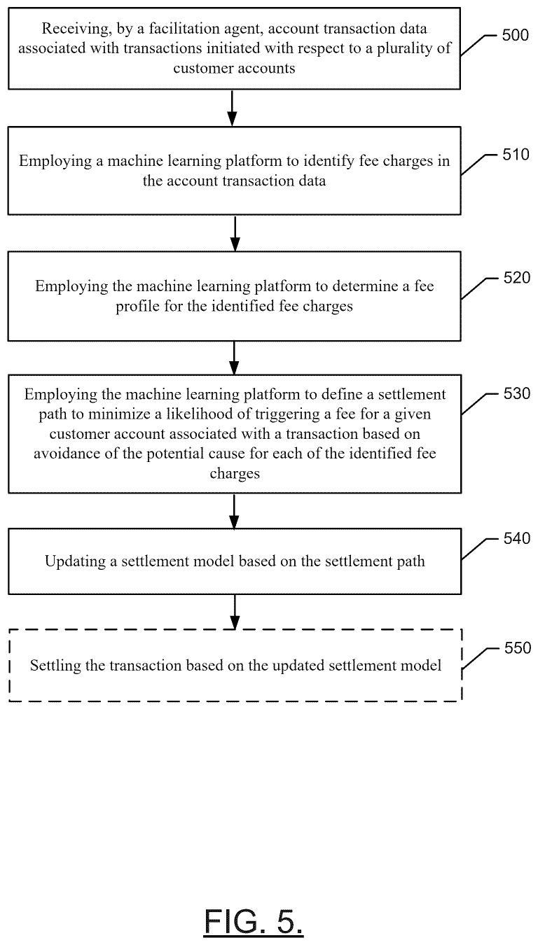

From a technical perspective, the payments platform 50 described above may be used to support some or all of the operations described above. As such, the apparatuses described in FIGS. 2 and 4 may be used to facilitate the implementation of several computer program and/or network communication based interactions. As an example, FIG. 5 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 42, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method for facilitating minimization of fees charged to customers with respect to electronic fund transfers associated with transactions according to one embodiment of the invention is shown in FIG. 5. The method may be performed by a facilitation agent at a server, computer or other processing circuitry associated with a facilitator. The method may include receiving, by the facilitation agent, account transaction data associated with transactions initiated with respect to a plurality of customer accounts at operation 500. The method may include employing a machine learning platform to identify fee charges in the account transaction data at operation 510. The method may also include employing the machine learning platform to determine a fee profile for the identified fee charges at operation 520. The fee profile may include a potential cause for each of the identified fee charges, although the cause may be as simple as the bank charging a fee for the associated activity, or a likelihood that the bank will charge a fee under these specific circumstances. The method may also include employing the machine learning platform to define a settlement path to minimize a likelihood of triggering a fee for a given customer account associated with a transaction based on avoidance of the potential cause for each of the identified fee charges at operation 530, and updating a settlement model based on the settlement path at operation 540. An optional operation 550 may further provide for settling the transaction based on the updated settlement model.

In an example embodiment, an apparatus for performing the method of FIG. 5 above may comprise a processor (e.g., the processor 102) or processing circuitry configured to perform some or each of the operations (500-550) described above. The processor may, for example, be configured to perform the operations (500-550) by performing hardware implemented logical functions, executing stored instructions, or executing algorithms for performing each of the operations. In some embodiments, the processor or processing circuitry may be further configured for additional operations or optional modifications to operations 500 to 550.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, the account transaction data may include unstructured data from a plurality of different banks, and identifying the fee charges may include employing a machine learned fee identification based on pattern recognition within the unstructured data. In an example embodiment, the machine learned fee identification may include feedback reinforced learning including one or more examples in which the facilitation agent obtains confirmation of a fee charged from a customer associated with one of the plurality of customer accounts, one or more examples in which the facilitation agent obtains confirmation of a fee charged by the facilitation agent receiving an insufficient funds notice for a failed transfer, or one or more examples in which the facilitation agent obtains confirmation of a fee charged from a bank associated with one of the plurality of customer accounts. In some cases, the machine learned fee identification may include feedback reinforced learning via a convolutional neural network (CNN) trained on known fee scenarios in which the known fee scenarios include identifying a value range known to correspond to the fee charges, identifying a money transfer within a predefined temporal proximity of the transaction, identifying a text string associated with the fee charges, or own failures initiated by the facilitator. In an example embodiment, the transaction may include an automated clearing house (ACH) transfer, and the fee may be associated with receiving an insufficient funds notice associated with the ACH transfer. In an example embodiment, the fee profile may be determined for a given bank or institution, and wherein the fee profile has a temporal validity component. In some cases, the fee profile may be further associated with a particular product offering of the given bank or institution.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method for facilitating minimization of fees charged to customers with respect to electronic fund transfers associated with transactions, the method comprising:
receiving, by a facilitation agent, account transaction data associated with transactions initiated with respect to a plurality of customer accounts;
employing a machine learning platform to identify fee charges in the account transaction data;
employing the machine learning platform to determine a fee profile for the identified fee charges, the fee profile including a potential cause for each of the identified fee charges;
employing the machine learning platform to define a settlement path to minimize a likelihood of triggering a fee for a given customer account associated with a transaction based on avoidance of the potential cause for each of the identified fee charges; and
updating a settlement model based on the settlement path.

2. The method of claim 1, wherein the account transaction data comprises unstructured data from a plurality of different banks, and
wherein identifying the fee charges comprises employing a machine learned fee identification based on pattern recognition within the unstructured data.

3. The method of claim 2, wherein the machine learned fee identification comprises feedback reinforced learning including one or more examples in which the facilitation agent obtains confirmation of a fee charged from a customer associated with one of the plurality of customer accounts.

4. The method of claim 2, wherein the machine learned fee identification comprises feedback reinforced learning including one or more examples in which the facilitation agent obtains confirmation of a fee charged by the facilitation agent receiving an insufficient funds notice for a failed transfer.

5. The method of claim 2, wherein the machine learned fee identification comprises feedback reinforced learning including one or more examples in which the facilitation agent obtains confirmation of a fee charged from a bank associated with one of the plurality of customer accounts.

6. The method of claim 2, wherein the machine learned fee identification comprises feedback reinforced learning via a convolutional neural network (CNN) trained on known fee scenarios, the known fee scenarios including:
identifying a value range known to correspond to the fee charges;
identifying a money transfer within a predefined temporal proximity of the transaction;
identifying a text string associated with the fee charges; or
own failures initiated by the facilitator.

7. The method of claim 1, further comprising settling the transaction based on the updated settlement model.

8. The method of claim 1, wherein the transaction includes an automated clearing house (ACH) transfer, and
wherein the fee is associated with receiving an insufficient funds notice associated with the ACH transfer.

9. The method of claim 1, wherein the fee profile is determined for a given bank or institution, and wherein the fee profile has a temporal validity component.

10. The method of claim 9, wherein the fee profile is further associated with a particular product offering of the given bank or institution.

11. An apparatus for execution by a facilitation agent to minimize fees charged to customers with respect to electronic fund transfers associated with transactions, the apparatus comprising processing circuitry configured to:
receive, by the facilitation agent, account transaction data associated with transactions initiated with respect to a plurality of customer accounts;
employ a machine learning platform to identify fee charges in the account transaction data;
employ the machine learning platform to determine a fee profile for the identified fee charges, the fee profile including a potential cause for each of the identified fee charges;
employ the machine learning platform to define a settlement path to minimize a likelihood of triggering a fee for a given customer account associated with a transaction based on avoidance of the potential cause for each of the identified fee charges; and
update a settlement model based on the settlement path.

12. The apparatus of claim 11, wherein the account transaction data comprises unstructured data from a plurality of different banks, and
wherein identifying the fee charges comprises employing a machine learned fee identification based on pattern recognition within the unstructured data.

13. The apparatus of claim 12, wherein the machine learned fee identification comprises feedback reinforced learning including one or more examples in which the facilitation agent obtains confirmation of a fee charged from a customer associated with one of the plurality of customer accounts.

14. The apparatus of claim 12, wherein the machine learned fee identification comprises feedback reinforced learning including one or more examples in which the facilitation agent obtains confirmation of a fee charged by the facilitation agent receiving an insufficient funds notice for a failed transfer.

15. The apparatus of claim 12, wherein the machine learned fee identification comprises feedback reinforced learning including one or more examples in which the facilitation agent obtains confirmation of a fee charged from a bank associated with one of the plurality of customer accounts.

16. The apparatus of claim 12, wherein the machine learned fee identification comprises feedback reinforced learning via a convolutional neural network (CNN) trained on known fee scenarios, the known fee scenarios including:
identifying a value range known to correspond to the fee charges;
identifying a money transfer within a predefined temporal proximity of the transaction;
identifying a text string associated with the fee charges; or
own failures initiated by the facilitator.

17. The apparatus of claim 11, wherein the processing circuitry is further configured to settle the transaction based on the updated settlement model.

18. The apparatus of claim 11, wherein the transaction includes an automated clearing house (ACH) transfer, and
wherein the fee is associated with receiving an insufficient funds notice associated with the ACH transfer.

19. The apparatus of claim 11, wherein the fee profile is determined for a given bank or institution, and wherein the fee profile has a temporal validity component.

20. The apparatus of claim 19, wherein the fee profile is further associated with a particular product offering of the given bank or institution.
